(19) United States
(12) Patent Application Publication
(10) Pub. No.: US 2010/0271323 A1
(43) Pub. Date: Oct. 28, 2010

(54) Soft Digital Tablet

(75) Inventors: Chien-Chia Lien, Hsin-Chu (TW); Kuang-Yao Hsieh, Hsin-Chu (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, Hsinchu (TW)

(21) Appl. No.: 12/765,691

(22) Filed: Apr. 22, 2010

(30) Foreign Application Priority Data
Apr. 23, 2009 (TW) 098113475

(51) Int. Cl. G06F 3/041; G06F 3/033

(52) U.S. Cl. 345/173; 345/179

(57) ABSTRACT

A soft digital tablet is disclosed. The soft digital tablet comprises a soft case, an antenna board and a control circuit board. The antenna board and the control circuit board induct and process electromagnetic signal from a digital pen, and transmit the processed electromagnetic signal to a host via a transmission line.

### FIELD OF THE INVENTION

The present invention relates to a digital tablet, and more particularly to a soft digital tablet integrating functions of a mouse pad and a digital tablet.

### DESCRIPTION OF THE PRIOR ART

Commercial products of a digital tablet or a digitizer usually include a stylus or an electromagnetic pen as a pointer and a digitizer or digital tablet. An electromagnetic pen usually has a circuit with capacitors and inductors. One way to display the width variation of the trace of the pointer resulting from the pressure applied on the digital tablet by the pointer on a display is to change the inductance as well as the frequency emitted by the pointer through the variation of the contact force applied on the digital tablet by the pointer. A digitizer often comprises signal detection and processing circuits including signal amplifiers, an analog to digital converter, a micro controller unit or a central processing unit, and a plurality of sensor coils or antennas on printed circuit boards to detect and process electromagnetic signals from the electromagnetic pen so as to transmit signals of coordinates, trace or frequency variation of the electromagnetic pen to a host and to show on a display.

Conventional digitizers or digital tablets comprise an upper case and a lower case both made of hard materials encasing an antenna board and a printed circuit board. The upper case which is used to contact with an electromagnetic pen is usually a hard plastic case formed by molding, while the lower case is also a hard plastic case or an iron case. The antenna board is usually a flexible board with a plurality of sensor coils or antennas thereon. However, the manufacture of the upper and lower cases need particular custom-made molds which are expensive and thus raise the production cost. Moreover, owing to the high cost and the limitation of mold design for hard cases of digital tablets, the flexibility of usage of digital tablets with hard cases is limited, and the appearance of digital tablets with hard cases also lacks variety.

In order to solve the above-mentioned drawbacks of conventional digitizers or digital tablets with hard cases, the invention provides a soft digital tablet to increase the flexibility of usage of digital tablets and to reduce the production cost.

### SUMMARY OF THE INVENTION

An object of the present invention is to provide a soft digital tablet to reduce the cost of mold and the production of digital tablets, and to increase the variety of appearance of digital tablets with hard cases.

According to the object, one embodiment of the present invention provides a soft digital tablet. The soft digital tablet comprises a soft case, an antenna board and a control circuit board. The antenna board and the control circuit board induct and process electromagnetic signals from an electromagnetic/digital pen, and transmit the processed electromagnetic signals to a host via a transmission line.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows an exploded view of a soft digital tablet according to one embodiment of the invention.

FIG. 2 shows a schematic diagram of a soft digital tablet connecting to a computer according one embodiment of the invention.

FIG. 3 shows a schematic diagram of the use of a soft digital tablet according one embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

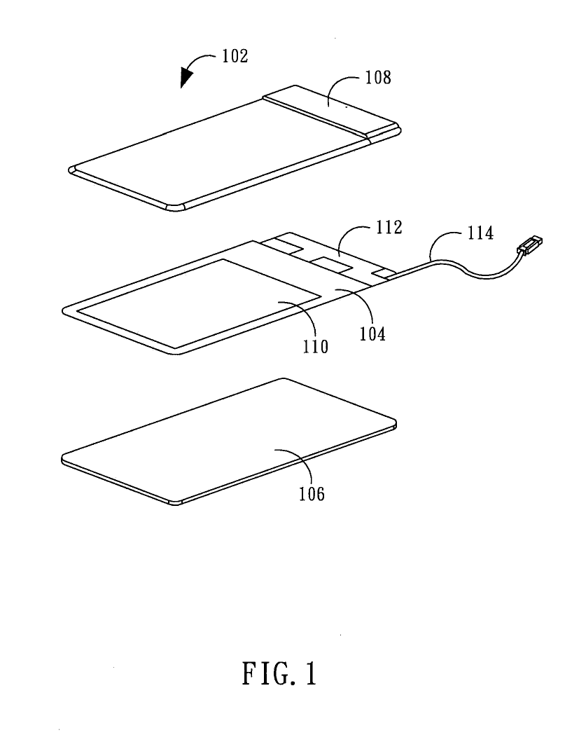

FIG. 1 shows an exploded view of a soft digital tablet according to one embodiment of the invention. The soft digital tablet 100 comprises an upper pad 102, an antenna board 104, a control circuit board 112 and a lower pad 106. The upper pad 102 and the lower pad 106 comprise soft insulating materials, including Polyurethane/PU Foam or plastic foam, rubber, and silicone etc. The soft digital tablet 100 comprises a case constituted by the upper pad 102 and the lower pad 106, but not limited a case constituted by the upper pad 102 and the lower pad 106. The soft digital tablet 100 includes a soft case enclosing the antenna board 104 and the control circuit board 112. The soft case encloses and seals the antenna board 104 and the control circuit board 112 by thermal bonding or an adhesive. Since the upper pad 102 and the lower pad 106 are made of soft materials, and the cost of developing the mold for soft materials is lower than the cost of developing the mold for hard materials, the production cost of the digital tablet can be decreased. Moreover, the weight of the digital tablet can be reduced, the convenience of carrying the digital tablet can be improved, and the impact resistance of the digital tablet can also be increased. The upper pad 102 comprises a protection pad 108 for protect and cover the control circuit board 112. The antenna board 104 comprises an electromagnetic senor region 110. The material of the antenna board 104 comprises a flexible plastic thin film including Polyester (PET), Polyvinylchloride (PVC), and Polystyrene (PS) etc. The electromagnetic senor region 110 comprises a plurality of antennas or sensor coils aligned along X and Y axes respectively. The antennas or sensor coils aligned along X and Y axes are arranged on two sides of the antenna board 104, and are connected via through holes to form a cross layout. The control circuit board 112 comprises a printed circuit board with a frequency calculating circuit, an analog signal amplifier, a signal filter and a micro controller, etc., to emit electromagnetic signals or to process electromagnetic signals emitted from a stylus or an electromagnetic pen. The processed electromagnetic signals are then calculated to generate coordinate data of the stylus or the electromagnetic pen, and the coordinate data are transmitted to a host such as a computer via a transmission line 114, and are displayed on a display. The upper pad 102 and the lower pad 106 can be bonded to enclose the antenna board 104 and the control circuit board 112 by thermal bonding. The upper pad 102 and the lower pad 106 can also be bonded to seal the antenna board 104 and the control circuit board 112 inside by an adhesive.

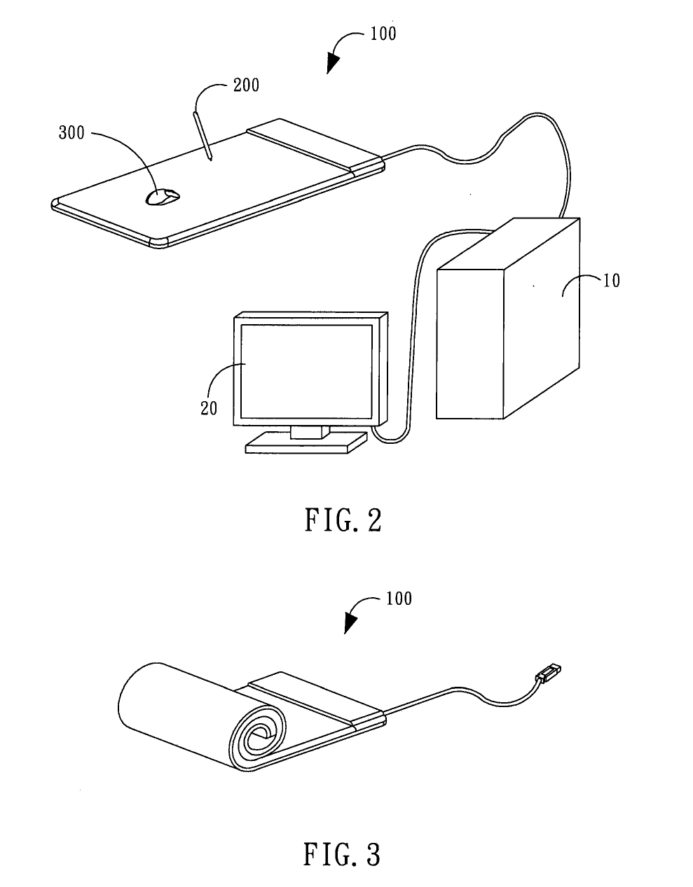

FIG. 2 shows a schematic diagram of a soft digital tablet 100 connecting to a computer 10 according one embodiment of the invention. The soft digital tablet 100 allows a user to use an electromagnetic pen 200 or a stylus on the upper pad 102. The electromagnetic pen 200 proceeds mutual induction and the electromagnetic signals sensed by the antennas or sensor coils of the antenna board 104 are processed by the frequency calculating circuit, the analog signal amplifier, the signal filter and the micro controller to generate coordinate data of the electromagnetic pen 200, and the coordinate data are transmitted to the computer 10. The computer 10 processes the positions, the traces and other data of the electromagnetic pen 200 such as contact force applied by the electromagnetic pen 200 on the soft digital tablet 100 through application software. The computer 10 displays the positions, the traces and the contact force applied by the electromagnetic pen 200 through the width variation of the trace of the electromagnetic pen 200 on a display 20. When the user uses other application programs on the computer 10 or a mouse 300, the mouse 300 can be used on the soft digital tablet 100, and the soft digital tablet 100 is used as a mouse pad. The mouse 300 includes a wireless mouse and a wired mouse. The electromagnetic pen 200 comprises a batteryless electromagnetic pen and a self-powered electromagnetic pen with batteries.

FIG. 3 shows a schematic diagram of the use of a soft digital tablet according one embodiment of the invention. Since the soft digital tablet 100 is constituted by the upper pad and the lower pad 106 made of soft insulating materials, and the antenna board 104 made of a flexible plastic thin film, the soft digital tablet 100 can be bended or rolled up so as to increase the convenience of carrying the soft digital tablet 100.

Since the upper pad and the lower pad for enclosing the antenna board and the control circuit board are made of soft materials, and the cost of developing the mold and the production cost of the digital tablet can be decreased. Moreover, the weight of the digital tablet can be reduced, the convenience of carrying the digital tablet can be improved, and the impact resistance of the digital tablet can also be increased. The digital tablet can further be used as a mouse pad so as to increase the flexibility of application of the digital tablet.

Although specific embodiments have been illustrated and described, it will be appreciated by those skilled in the art that various modifications may be made without departing from the scope of the present invention, which is intended to be limited solely by the appended claims.

What is claimed is:

1. A digital tablet, said digital tablet comprising:
A case of a soft material enclosing an antenna board and a control circuit board, the antenna board and the control circuit board sensing and processing electromagnetic signals emitted from an electromagnetic pen respectively, the control circuit board transmitting the processed electromagnetic signals to a host through a transmission line.

2. The digital tablet according to claim 1, wherein the case comprises an upper pad and a lower pad.

3. The digital tablet according to claim 2, wherein the upper pad comprises a protection pad to protect and cover the control circuit board.

4. The digital tablet according to claim 1, wherein the soft material comprises at least one of polyurethane (PU), plastic foam, rubber or silicone.

5. The digital tablet according to claim 1, wherein the electromagnetic pen comprises a batteryless electromagnetic pen.

6. The digital tablet according to claim 1, wherein the electromagnetic pen comprises an electromagnetic pen with batteries.
